(19) United States
(12) Patent Application Publication
(10) Pub. No.: US 2006/0127150 A1
(43) Pub. Date: Jun. 15, 2006

(54) Image forming device, image forming method, and computer readable storage medium storing image forming program

(75) Inventor: Nobuyuki Kimura, Chofu-shi (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: KONICA MINOLTA BUSINESS TECHNOLOGIES, INC., Tokyo (JP)

(21) Appl. No.: 11/125,178

(22) Filed: May 10, 2005

(30) Foreign Application Priority Data
Dec. 14, 2004 (JP) 2004-361342

(51) Int. Cl. G03G 15/00

(52) U.S. Cl. 399/405

(57) ABSTRACT

A printer, as an image forming device, identifies the direction of the shift of the tab on each of the index sheets stacked in paper trays, identifies as to whether the sheets to be fed to the printing unit with the top surface of each index sheets stacked in the paper trays presented as a printing surface, or the bottom surface of the index sheets to be presented as a printing surface, and determines the printing page order of the printing job data in accordance with the identified tab shifting direction information and the paper feeding surface information.

This application is based on Japanese Patent Application No. 2004-361342, filed on Dec. 14, 2004, the contents of which are hereby incorporated by reference.

### BACKGROUND OF THE INVENTION

1. Field of the Invention

The present invention relates to an image forming device, an image forming method, and a computer-readable storage medium storing an image forming program, specifically an image forming device, an image forming method, and a computer-readable storage medium for storing an image forming program for printing a tab portion of an index sheet.

2. Description of the Related Art

There are certain image forming devicees such as copying machines and printers that are capable of printing a tab portion of an index sheet consisting of a main portion and a tab portion that protrudes at a certain specified location from the main portion.

FIG. 1 is a diagram showing how multiple index sheets are lined up.

When multiple index sheets are stored in an image forming device, they are lined up in a specific lineup order of either A or B. The lineup order of index sheets as shown in A is called straight collation and tabs 1 of upper layers of index sheets are located higher than tabs 1 of lower layers when the tabs 1 are located on the right side. The lineup order of index sheets as shown in B is called reverse collation and tabs 1 of upper layers of index sheets are located lower than tabs 1 of lower layers when the tabs 1 are located on the right side. Sets of index sheets each of which is consisting of a specified number of index sheets lined up in straight or reverse collation are available on the market, and the number of sheets varies with those sets of index sheets.

The following technologies are established concerning printings on the tabs of those index sheets.

For example, there is a copying machine which prints on the tabs of a plurality of sets of index sheets stored in the paper tray and discharges the printed sheets in such a way that the index sheets having their tabs in the same position are stacked in the same bin (Unexamined Publication No. JP-A-H08-73110).

There is also an image forming device that determines the image forming location on the tab of a supplied index sheet based on the information concerning the shapes and locations of the tabs of various index sheets stored in a memory unit and an image obtained by scanning a particular supplied index sheet (Unexamined Publication No. JP-A-2000-132005).

There is also a technology of printing on the tab of an index sheet by selecting a particular paper tray where a set of appropriate number of index sheets is stored based on information provided by the user, which is suitable for a particular filing job, when a set of different number of index sheets is stored in each paper tray (Unexamined Publication No. JP-A-2001-278530).

There is also a technology of printing an image on the tab of an index sheet by shifting only the particular image to be printed on the tab to an area that corresponds to the location of the tab, which protrudes from the edge of a page layout, when the tab area is embedded in a particular area of the page layout (Unexamined Publication No. JP-A-2002-316454).

When printing the tab 1 using an image forming device, the user must keep in mind the following points.

When printing is performed from the first page and a straight feeding paper tray is used, which is designed for supplying paper straight to printing means such as a photo conductive drum to use the top surface of index sheets as they are stacked in the tray as the printing surface, the tab 1 can be properly printed when the index sheets are stored in straight collation in the particular straight feeding paper tray.

On the other hand, when printing is performed from the first page and a reverse feeding paper tray is used, which is designed for supplying paper straight to said printing means in such a way as to use the bottom surface of index sheets as they are stacked in the tray as the printing surface, it results in reversing the index sheet so that the location of the tab 1 changes relative to the main portion of the sheet thus ending up in falsely printing in the location where the tab 1 does not exist. Therefore, it is necessary for the index sheets to be stored in the reverse feeding paper tray in reverse collation in such a case.

However, if the user fails to recognize whether the paper tray storing index sheets is a straight feeding paper tray or a reverse feeding paper tray, it is impossible for the user to judge whether to set the index sheets in straight collation or in reverse collation in the particular paper tray.

Moreover, the user has to consider the page printing order for a particular printing job. For example, when the last page is printed first, printing in reverse collation, and the straight feeing paper tray is used, index sheets must be stored in said straight feeding paper tray in reverse collation. Thus, in printing the tab 1, the user must make a judgment whether three factors, i.e., the order of stacking index sheets, the type of the paper tray, and the page printing order, are in a proper relation. This not only makes the user feel cumbersome with an extra burden but also may cause a failure in printing on the tab 1 if the user makes a judgment error. Nothing is mentioned about the relation between the order of stacking index sheets, the type of paper tray, and the page printing order.

### OBJECTS AND SUMMARY

It is an object of the present invention to provide an image forming device, an image forming method, and a computer readable storage medium for storing an image forming program, which are improved for solving the abovementioned problems.

It is amore detailed object of the present invention to provide an image forming device, an image forming method, and a computer readable storage medium for storing an image forming program for printing tabs of index sheets more securely and easily.

According to an embodiment of the invention, there is provided an image forming device according to claim 1.

The present invention enables one to acknowledge securely the page printing order necessary for properly printing the printing data of a plurality of pages based on the information on whether the index sheets stacked in the paper feeding means are to be supplied to the printing means with their top surfaces as the printing surfaces, or their bottom surfaces as the printing surfaces, and the information on the tab portion shifting direction of the index sheets stacked in the paper feeding means. This enables one to print the tab portion of an index sheet more securely and easily and prevent printing errors.

According to an embodiment of the invention, there is provided an image forming device according to claim 4.

According to another embodiment of the invention, there is provided an image forming method according to claim 8.

According to another embodiment of the invention, there is provided an image forming method according to claim 9.

According to still another embodiment of the invention, there is provided a computer readable storage medium for storing an image forming program according to claim 10.

According to still another embodiment of the invention, there is provided a computer readable storage medium for storing an image forming program according to claim 11.

The objects, features and characteristics of this invention other than those set forth above will become apparent from the description given herein below with reference to preferred embodiments illustrated in the accompanying drawings.

### BRIEF DESCRIPTION OF THE DRAWINGS

FIG. 1 is a diagram showing how multiple index sheets are lined up.

FIG. 2 is a block diagram showing the overall constitution of a printing system according to a first embodiment of the present invention.

FIG. 3 is a block diagram showing the constitution of a personal computer.

FIG. 4 is a block diagram showing the constitution of a printer.

FIG. 5 is a schematic cross section of a printer.

FIG. 6 is a flowchart showing the process procedure on the personal computer.

FIG. 7 is a flowchart showing the process sequence on the printer.

FIG. 8 is a diagram showing an example of printing setup screen to be displayed on a display of the personal computer.

FIG. 9 is a flowchart showing the process of the personal computer according to a second embodiment.

FIG. 10 is a flowchart showing the process sequence on the printer in the second embodiment.

### DETAILED DESCRIPTION OF PREFERRED EMBODIMENT

The embodiment of this invention will be described below with reference to the accompanying drawings.

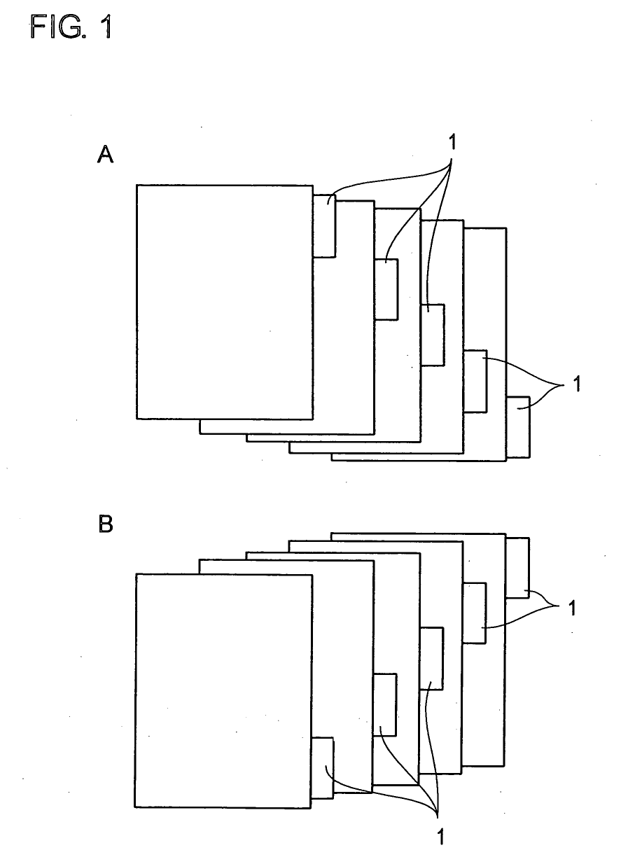

An index sheet having a tab portion 1 protruding on one edge of the sheet as shown in FIG. 1 can be used in this invention as well.

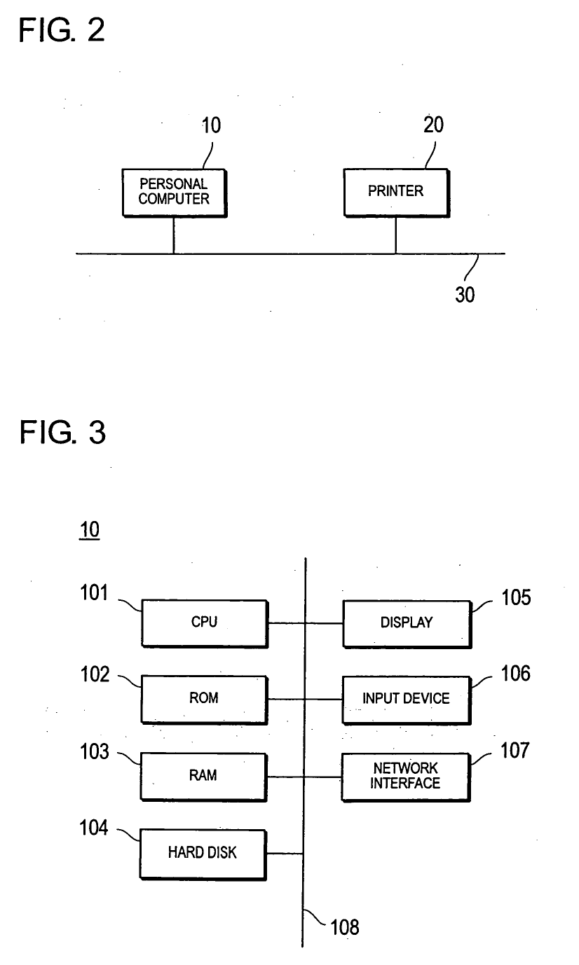

FIG. 2 is a block diagram showing the overall constitution of a printing system according to a first embodiment of the present invention. The printing system according to the first embodiment is equipped with a personal computer 10 and a printer 20 as an image forming device, which are interconnected via a network 30 to enable communications between them. The network 30 can be a LAN connecting computers and network equipment according to standards such as Ethernet®, Token Ring, and FDDI, or a WAN that consists of several LANs connected by a dedicated line.

Next, the constitution of each device will be described and it is noted here that each of those devices can include constituents other than those to be described later or can include only a part of the constituents to be described later.

FIG. 3 is a block diagram showing the constitution of the personal computer 10. The personal computer 10 contains a CPU (Central Processing Unit) 101, a ROM 102, a RAM 103, a hard disk 104, a display 105, an input device 106 and a network interface 107, all of which are interconnected by a bus 108 for exchanging signals.

The ROM 102 stores various programs and data. The RAM 103 stores programs and data temporarily as a working area. The hard disk 104 stores various programs including an operating system and data.

Moreover, application software for preparing and editing documents and a printer driver for converting document files instructed by the application software into a language that the printer controller can understand (e.g., PDL (Page Description Language) such as Post Script®) are installed on the hard disk 104.

The display 105 is, for example, a liquid crystal display device for displaying various kinds of information. The input device 106 is a pointing device such as a mouse, a keyboard, and others, and is used for making various kinds of inputs.

The network interface 107 is an interface to connect with the network 30 for communicating with other devices on the network using standards such as Ethernet®, Token Ring, FDDI, etc.

A printing job is prepared by the printer driver installed on the personal computer 10 based on various data such as document data prepared by various application software, business form data provided by business form systems or image data prepared by image processing software. The printing job prepared by the personal computer 10 is transmitted to the printer 20 via the network 30.

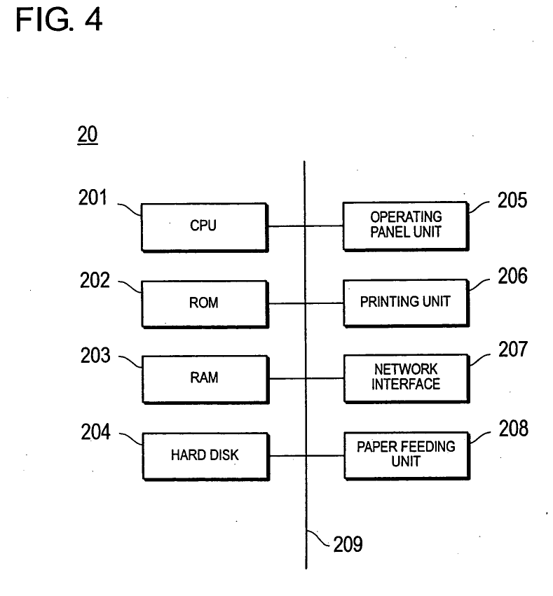

FIG. 4 is a block diagram showing the constitution of printer 20. The printer 20 has a CPU 201, a ROM 202, a RAM 203, a hard disk 204, an operating panel unit 205, a printing unit 206, a network interface 207, and a paper feeding unit 208, all of which are interconnected with each other via a bus 209 for exchanging signals. The operating panel unit 205 consists of a touch panel, fixed keys outside of the touch panel, indicator lamps and others used for various inputting and displaying purposes. The printing unit 206 executes printing based on a printing job.

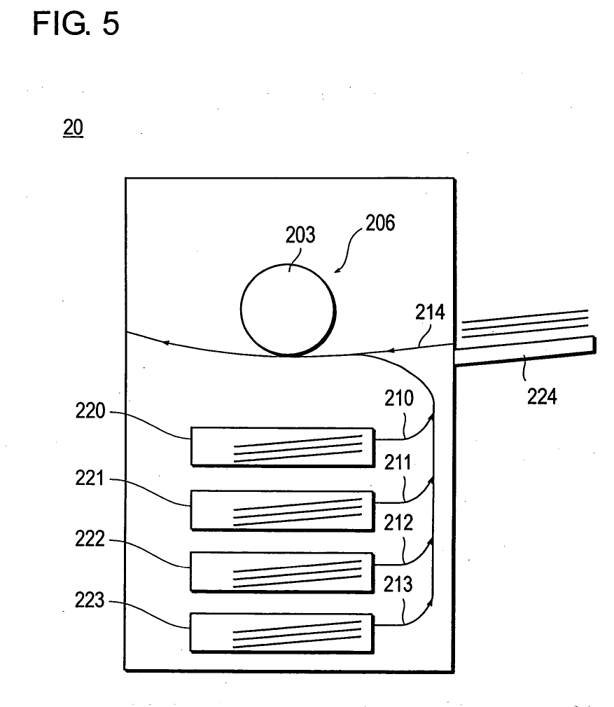

FIG. 5 is a brief cross section of the printer 20.

The printing unit 206 has, for example, a photo conductive drum 230 for printing data on printing paper based on an image forming method such as an electronic photograph method.

The paper feeding unit 208 has rollers (not shown) such as feed rollers for transporting printing paper, a sensor (not shown) for optically detecting the passage of printing paper, transporting routes 210 through 214 for transporting paper to the printing unit 206, paper trays 220 through 223 storing printing paper, and a manual feeding tray 224.

The paper trays 220 through 223 are reverse feeding paper trays. For example, a sheet on top of the sheets stored in one of the paper trays 220 through 223 is picked up by the feed rollers (not shown) and is supplied via a transport route 210-223 to the photo conductive drum 230 of the printing unit 206 after being reversed so that the surface, which used to be the bottom surface when it was stored in one of the paper trays 220 through 223, is presented as the printing surface.

On the other hand, the manual feeding tray 224 is a straight feeding paper tray. A sheet on top of the sheets stored in the manual feeding tray 224 is picked up by the feed rollers (not shown) and is supplied via the transport route 214 to the photo conductive drum 230 of the printing unit 206 after being reversed so that the surface, which used to be the top surface when it was stored in the manual feeding tray 224, is presented as the printing surface.

In a filing process using index sheets, it is a common practice to insert the index sheets among documents in straight collation shown as A in FIG. 1.

In order to insert index sheets into documents in straight collation, it is necessary for the user to recognize three items, i.e., 1) whether the paper tray where the index sheets are stored is a reverse feeding paper tray or a straight feeding paper tray; 2) whether the stored index sheets are stacked in straight collation or reverse collation; and 3) whether the page printing order for the particular printing job is straight collation or reverse collation.

This embodiment is, when two of the three items mentioned above are identified, to select or determine the third item so that the index sheets will be inserted properly into the document.

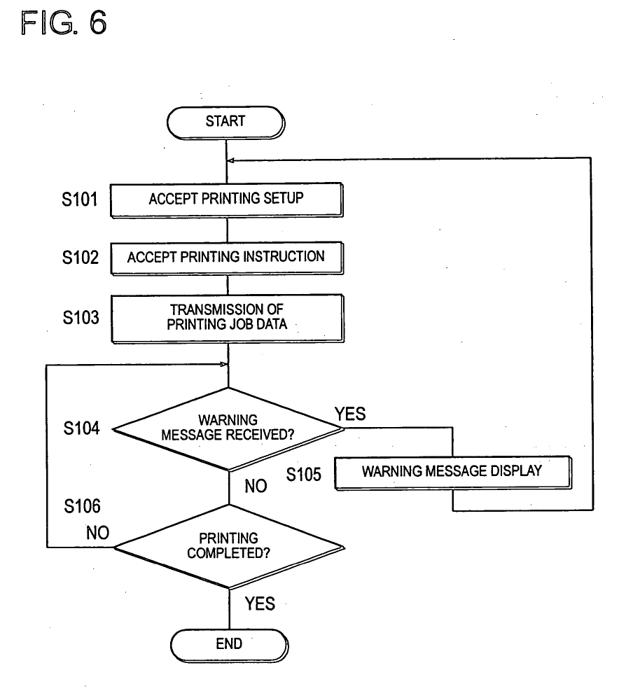

Next, the processes performed at the personal computer 10 and the printer 20 in the first embodiment will be described referring to FIGS. 6 through 8.

The algorithm shown in the flowchart of FIG. 6 is stored as a control program in a memory unit such as the ROM 102 or the hard disk 104 of the personal computer 10 and executed by the CPU 101.

First, a printing setup is accepted in accordance with a printer driver setup screen displayed on the display 105 of the personal computer 10 (S101).

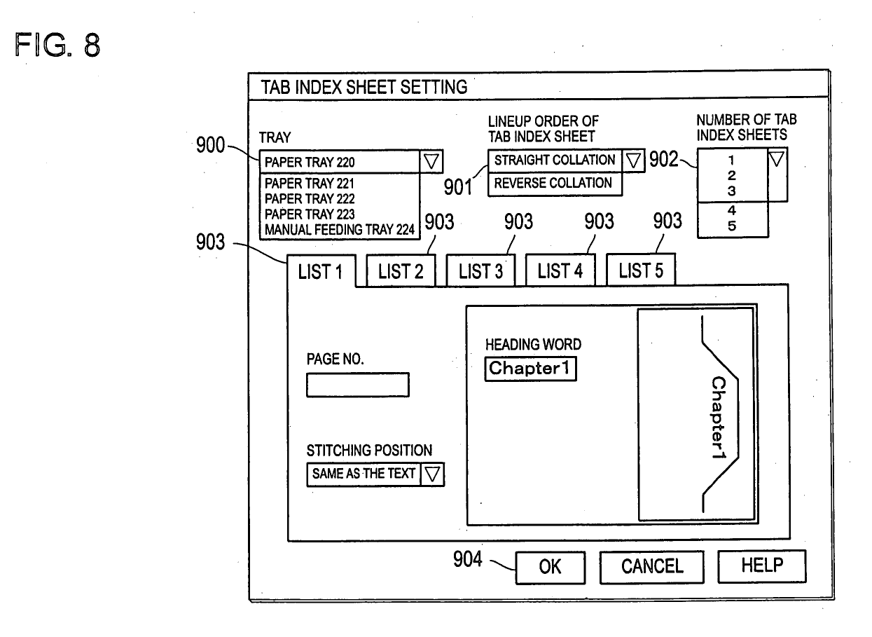

FIG. 8 is a diagram showing an example of printing setup screen to be displayed on the display 105 of the personal computer 10. The user can enter various items concerning the printing setup using pull down menus and text inputs on the printing setup screen.

The numeric code 900 denotes a tray selection menu with which the user can select one of the paper trays 220 through 223 or the manual feeding tray 224 from the pull down menu.

The numeric code 901 denotes a lineup order selection menu for index sheets and allows the user to select either “straight collation” or “reverse collation” from the pull-down menu.

The numeric code 902 denotes a number of sheets selection menu for index sheets and allows the user to select the number of index sheets to be used based on the pull down menu.

The numeric code 903 is a setup menu for index sheets and allows the user to setup the indices as many as the number specified by the menu 902. FIG. 8 shows a case where five index sheets are involved.

Returning to FIG. 6, the personal computer 10 accepts a printing instruction when the user presses the OK button 904 shown in FIG. 8 (S102), and transmits printing job data containing printing setup information specified in the step S101 to the printer 20 (S103). When the personal computer 10 receives from the printer 20 a warning message prompting removal of shortcomings in the printing setup (S104: Yes) after transmitting printing job data in the step S103 and prior to completion of printing, it displays said warning message on the display 105 (S105). With this warning message display, the user can redo the printing setup to remove the shortcomings on the printing setup screen. When it did not receive said warning message from the printer 20 (S104: No), it makes a judgment as to whether printing is completed or not (S106). If it is judged that the printing is not completed (S106: No), the program returns to the step S104.

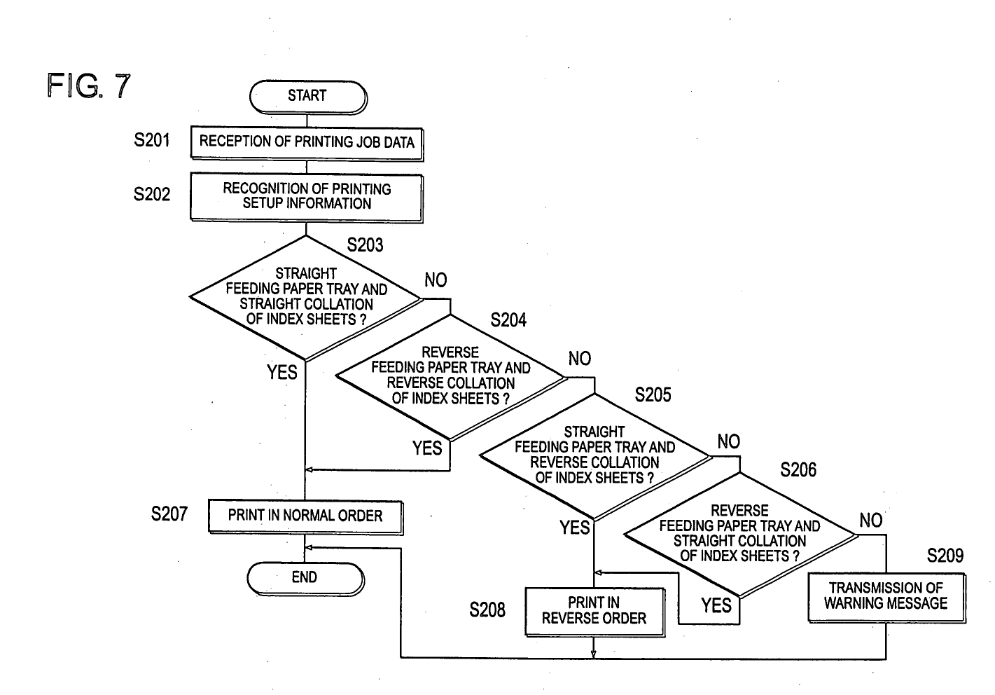

Next, the process on the printer 20 will be described referring to FIG. 7.

The algorithm shown in the flowchart of FIG. 7 is stored as a control program in a memory unit such as the ROM 202 or the hard disk 204 of the printer 20 and executed by the CPU 201.

The printer 20 receives a printing job data transmitted from the personal computer 10 (S201), and recognizes the printing setup information in the printing job data (S202). The printing setup information contains the aforementioned information about the paper trays and the lineup order of the index sheets. First, in the step S203, a judgment is made as to whether the paper tray is a straight feeding paper tray (i.e., manual feeding tray 224) and the lineup order of the index sheets is straight collation or not. In case of a combination of the straight feeding paper tray and straight collation of the index sheets (S203: Yes), index sheets are fed to be printed starting from those with the tabs 1 in upper positions, so that the printing page order of the printing job data is set up in the normal order (S207). In case it is judged NO in the step S203, it advances to the step S204 and a judgment is made as to whether the paper tray is the reverse feeding paper tray (i.e., the payer trays 221 through 223) and the lineup order of the index sheets is reverse collation or not. In case of a combination of the reverse feeding paper tray and reverse collation of the index sheets (S204: Yes), index sheets are fed to be printed starting from those with the tabs 1 in lower positions and flipped over before they reach the printing unit 206 to be printed on the reverse side thereof in order to make the tabs 1 will be on the upper side as a result, so that the printing page order of the printing job data is set up in the normal order (S207) In case it is judged NO in the step S204, it advances to the step S205 and a judgment is made as to whether the paper tray is the straight feeding paper tray (i.e., the manual feeding trays 224) and the lineup order of the index sheets is reverse collation or not. In case of a combination of the straight feeding paper tray and reverse collation of the index sheets (S205: Yes), the index sheets are fed to be printed starting from those with the tabs 1 in lower positions, so that the printing page order of the printing job data is set up in the reverse order (S208). In case it is judged NO in the step S205, it advances to the step S206 and a judgment is made as to whether the paper tray is the reverse feeding paper tray (i.e., the payer trays 221 through 223) and the lineup order of the index sheets is straight collation or not. In case of a combination of the reverse feeding paper tray and straight collation of the index sheets (S206: Yes), index sheets are fed to be printed starting from those with the tabs 1 in upper positions and flipped over before they reach the printing unit to be printed on the reverse side thereof in order to make the tabs 1 will be on the lower side as a result, so that the printing page order of the printing job data is set up in the reverse order (S208). When it is judged to be NO in the step S206, it advances to the step S209 to transmit a warning message to the personal computer 10. The warning message issued in the step S209 is for the personal computer 10 to indicate that the paper tray or the lineup order of the index sheets need to be selected when the printing page order cannot be determined because the paper tray or the lineup order of the index sheets is not selected. It can also be a warning message for prompting the input of the printing page order.

As can be seen from the above, according to the present embodiment, it is possible to understand securely and decide the printing page order necessary for proper printing in accordance with the aforementioned information about the paper tray and lineup orders of the index sheets on a printer capable of printing either from the first page or from the last page in proper orders for printing job data consisting of a plurality of pages. This enables one to print the tab portion of an index sheet more securely and easily and prevent printing errors.

The process shown from the step S101 to the step S103 on the personal computer 10 as shown in FIG. 6 can be performed on the printer 20 as well. In this case, the receiving of the printing setup in the step S201 shown in FIG. 7 and the recognition of the printing setup information in the step S202 are changed to the receiving of the printing job data in the step S101 shown in FIG. 6 and the receiving of the printing instruction in the step S102. The printing setup screen shown in FIG. 8 is displayed on the operating panel unit 205 of the printer 20.

Also, the process in the step S203 through the step S206 is not limited by the execution order shown in the diagram, but rather can be executed in any order.

Next, the second embodiment of the invention will be described below.

The second embodiment shown is applicable to a printer which is only capable of printing job data consisting of a plurality of pages sequentially from the first page or from the last page because the capacity of its RAM 203 is limited.

Furthermore, since the constitution of the printing system and the hardware constitution of the equipment contained in said printing system are identical to those of the first embodiment, further descriptions are omitted but the personal computer and the printer of the second embodiment are identifies as a personal computer 11 and a printer 21 respectively to avoid confusions with those of the first embodiment.

The printing system in the second embodiment recognizes the type of paper tray storing index sheets and the lineup order of the stored index sheets, makes a judgment as to whether the receiving page order of the printing job data received from the personal computer 11 is a proper page order for proper printing or not, and issues a warning to the user that the job cannot be printed if a judgment is made that the received page order is not the order necessary for the proper printing.

Next, the process performed by the personal computer 11 and the printer 21 in the second embodiment will be described.

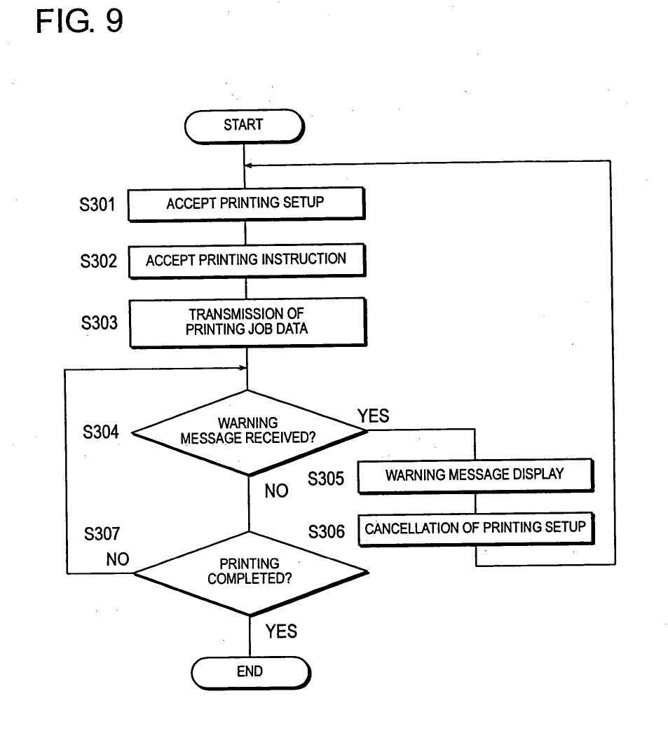

First, the process on the personal computer 11 will be described referring to FIG. 9.

The algorithm shown in the flowchart of FIG. 9 is stored as a control program in a memory unit such as the ROM 102 or the hard disk 104 of the personal computer 11 and executed by the CPU 101.

The process from the accepting of the printing setup (S301) to the transmission of the printing job data (S303) is identical to that of the step S101 to the step S103 shown in FIG. 6 so that its description is not repeated here. The printing setup screen is the same as the one shown in FIG. 8.

When the personal computer 11 receives a warning message that the printing job cannot be printed from the printer 21 after transmitting the printing job data in the step S303 before printing is completed (S304: Yes), said warning message is displayed on the display 105 (S305) and cancels the printing setup (S306). This cancellation of the printing setup allows the user to reset the printing setup in the printing setup screen. It can also be constituted in such a way as to display the warning message only in the step S305 or to cancel the printing setup only in the step S306. When it did not receive said warning message from the printer 21 (S304: No), it makes a judgment as to whether printing is completed or not (S307). If it is judged that the printing is not completed (S307: No), the program returns to step S304.

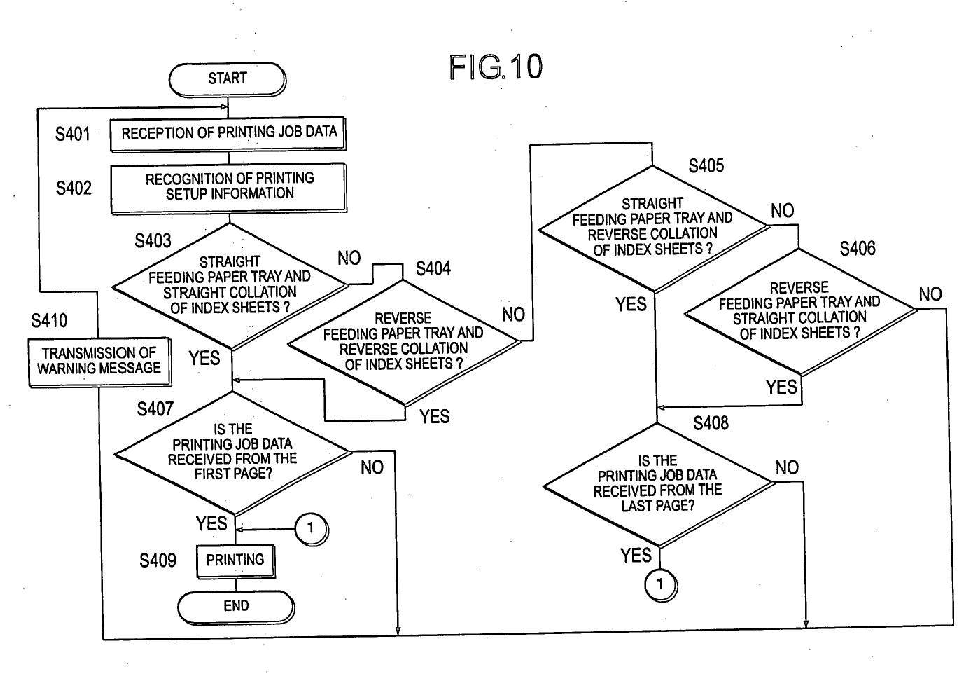

Next, the process on the printer 21 will be described referring to FIG. 10.

The algorithm shown in the flowchart of FIG. 10 is stored as a control program in a memory unit such as the ROM 202 or the hard disk 204 of the printer 21 and executed by the CPU 201.

The process in the step S401 through the step S406 is identical to the process in the step S201 through the step S206 in the first embodiment, so that its description is omitted here.

If the judgments are Yes in both the steps S403 and S404, the lineup order of the index sheets stored in the paper trays and the printing surfaces are the same as in the case when the judgments are Yes in both the steps S203 and S204 in the first embodiment, so that a judgment is made as to whether the printing job data is received in a sequential order from the first page or not (S407). If the printing job data is received in a sequential order from the first page (S407: Yes), the printer 21 starts printing from the first page of the printing job (S409). If the printing job data is not received in a sequential order from the first page (S407: No), the printer 21 judges that the received printing job data cannot be printed, and transmits a warning message indicated said judgment result to the personal computer 11 (S410).

Next, if the judgments are Yes in both the steps S405 and S406, the lineup order of the index sheets stored in the paper trays and the printing surfaces are the same as in the case when the judgments are Yes in both the steps S205 and S206 in the first embodiment, so that a judgment is made as to whether the printing job data is received in a sequential order from the last page or not (S408). If the printing job data is received in a sequential order from the last page (S408: Yes), the printer 21 starts printing from the last page of the printing job (S409). If the printing job data is not received in a sequential order from the last page (S408: No), the printer 21 judges that the received printing job data cannot be printed, and transmits a warning message indicated said judgment result to the personal computer 11 (S410).

Furthermore, if the judgment in the step S406 is No, it means that the paper trays and the lineup order of the index sheets are not yet selected as in the case of the judgment being No in the step S206 of the first embodiment, so that the printer 21 transmits a warning message to the personal computer 11 as in the step S209 (S410).

As can be seen from the above, according to the present embodiment, it is possible to understand securely the printing page order necessary for proper printing and decide whether the received printing job data can be printed or not on a printer capable of printing either from the first page or from the last page in proper orders in accordance with the aforementioned information about the paper tray and lineup orders of index sheets. Further, it issues a warning to the user if an erroneous printing setup is made concerning the printing on the tab for the printing job data. Consequently, the user learns that the printing setup was wrong and can enter a new printing setup to achieve a proper printing result.

It is obvious that this invention is not limited to the particular embodiments shown and described above but may be variously changed and modified without departing from the technical concept of this invention.

For example, in the printing systems in the first and second embodiment, it is possible to constitute in such a way as to provide a sensor, such as an optical sensor, for detecting the position of the tab of the index paper stored in the paper tray and identify the shifting direction of the tab portion with the sensor. In such a case, there is no need for an input box for the lineup order of the index sheets for the printing setup screen shown in FIG. 8. Thus, the user can be freed from trouble of confirming the lineup order of the index sheets stored in the tray.

The printing system according to this invention can also be applied to a printer which is equipped with only straight feeding paper trays or reverse feeding paper trays.

The processes (except the receiving process of printing job data and the printing execution process) in the printers shown in FIG. 7 and FIG. 10 are applicable to data transmission devices such as personal computers, etc. In this case, the data transmission device receives from the printer and stores the paper tray information concerning whether each paper tray provided on the printer is a straight feeding tray or a reverse feeding tray. The data transmission device confirms the printing page order necessary for properly printing the printing job data from the paper tray information and the lineup order information of the index sheets to be entered on the printing setup screen by the user. The lineup order information of the index sheets can be detected by a sensor provided in the printer and received from said printer.

The means and method of conducting various processes in the printing system according to the present invention can be realized by means of a dedicated hardware circuit, or a programmed computer. Said program can be provided either by a computer readable recording medium such as a flexible disk and a CD-ROM, or by being supplied on-line via a network such as the Internet. In this case, the program recorded on the computer readable recording medium is normally transferred to and stored in a memory device such as a hard disk. Said program can also be provided as independent application software or can be built into the software of the image forming device or the data transmission device as a part of its function.

What is claimed is:

1. An image forming device, comprising:
a paper feeding unit for stacking and storing index sheets each of which is provided with a tab protruding at a certain part of a side thereof;
a printing unit for printing on the index sheets transported from the paper feeding unit;
a receiving unit for receiving printing data consisting of a plurality of pages;
a tab shifting direction identifying unit for identifying the direction of the shift of the tab on each of the index sheets stacked in the paper feeding unit;
a paper feeding surface identifying unit for identifying as to whether the sheets to be fed to the printing unit with the top surface of each index sheets stacked in the paper feeding unit presented as a printing surface, or the bottom surface of the index sheets to be presented as a printing surface; and
a printing control unit for determining the printing page order of the printing data in accordance with the identified tab shifting direction information and paper feeding surface information.

2. An image forming device as claimed in claim 1, further comprising:
a tab shifting direction input unit, said tab shifting direction identifying unit identifies the shifting direction of the tab of the index sheets stacked in the paper feeding unit in accordance with the input information.

3. An image forming device as claimed in claim 1, further comprising:
a tab detection unit for optically detecting the location of said tab, said shifting direction identification unit identifies the shifting direction of the tab of the index sheets stacked in the paper feeding unit based on the detected location of the tab.

4. An image forming device, comprising:
a paper feeding unit for stacking and storing index sheets each of which is provided with a tab protruding at a certain part of a side thereof;
a printing unit for printing on the index sheets transported from the paper feeding unit;
a receiving unit for receiving printing data consisting of a plurality of pages;
a tab shifting direction identifying unit for identifying the direction of the shift of the tab on each of the index sheets stacked in the paper feeding unit;
a paper feeding surface identifying unit for identifying as to whether the sheets to be fed to the printing unit with the top surface of each index sheets stacked in the paper feeding unit presented as a printing surface, or the bottom surface of the index sheets to be presented as a printing surface; and
a printing control unit for determining whether it is possible or not to print the received printing data in accordance with the identified tab shifting direction information and paper feeding surface information.

5. An image forming device as claimed in claim 4, further comprising
a notifying unit for notifying that it is impossible to print when said printing control unit has decided that it is impossible to print.

6. An image forming device as claimed in claim 4, further comprising:
a tab shifting direction input unit wherein said tab shifting direction identifying unit identifies the shifting direction of the tab of the index sheets stacked in the paper feeding unit in accordance with the input information.

7. An image forming device as claimed in claim 4, further comprising:
a tab detection unit for optically detecting the location of said tab, said tab shifting direction identifying unit identifies the shifting direction of the tab of the index sheets stacked in the paper feeding unit based on the detected location of the tab.

8. An image forming method using an image forming device having a paper feeding unit for stacking and storing index sheets each of which is provided with a tab protruding at a certain part of a side thereof and a printing unit for printing on the index sheets transported from the paper feeding unit, comprising the steps of:
1) receiving printing data consisting of a plurality of pages;
2) identifying the direction of the shift of the tab on each of the index sheets stacked in the paper feeding unit;
3) identifying as to whether the sheets to be fed to the printing unit with the top surface of each index sheets stacked in the paper feeding unit presented as a printing surface, or the bottom surface of the index sheets to be presented as a printing surface; and
4) determining the printing page order of the printing data in accordance with the identified tab shifting direction information and paper feeding surface information.

9. An image forming method using an image forming device having a paper feeding unit for stacking and storing index sheets each of which is provided with a tab protruding at a certain part of a side thereof and a printing unit for printing on the index sheets transported from the paper feeding unit, comprising the steps of:
1) receiving printing data consisting of a plurality of pages;
2) identifying the direction of the shift of the tab on each of the index sheets stacked in the paper feeding unit;
3) identifying as to whether the sheets to be fed to the printing unit with the top surface of each index sheets stacked in the paper feeding device presented as a printing surface, or the bottom surface of the index sheets to be presented as a printing surface; and
4) determining whether it is possible or not to print the printing data in accordance with the identified tab shifting direction information and paper feeding surface information.

10. A computer readable storage medium for storing an image forming program for controlling an image forming device having a paper feeding unit for stacking and storing index sheets each of which is provided with a tab protruding at a certain part of a side thereof and a printing unit for printing on the index sheets transported from the paper feeding unit, said image forming program causes a computer to execute a process comprising the steps of:
1) identifying the direction of the shift of the tab on each of the index sheets stacked in the paper feeding unit;
2) identifying as to whether the sheets to be fed to the printing unit with the top surface of each index sheets stacked in the paper feeding unit presented as a printing surface, or the bottom surface of the index sheets to be presented as a printing surface; and
3) determining the printing page order of the printing data consisting of a plurality of pages, which is received by the image forming device, in accordance with the identified tab shifting direction information and paper feeding surface information.

11. A computer readable storage medium for storing an image forming program for controlling an image forming device having a paper feeding unit for stacking and storing index sheets each of which is provided with a tab protruding at a certain part of a side thereof and a printing unit for printing on the index sheets transported from the paper feeding unit, said image forming program causes a computer to execute a process comprising the steps of:
1) identifying the direction of the shift of the tab on each of the index sheets stacked in the paper feeding unit;
2) identifying as to whether the sheets to be fed to the printing unit with the top surface of each index sheets stacked in the paper feeding unit presented as a printing surface, or the bottom surface of the index sheets to be presented as a printing surface; and
3) determining whether it is possible or not to print the printing data consisting of a plurality of pages, which is received by the image forming device, in accordance with the identified tab shifting direction information and paper feeding surface information.
